(19) United States
(12) Patent Application Publication
(10) Pub. No.: US 2006/0126598 A1
(43) Pub. Date: Jun. 15, 2006

(54) Method for establishing an Internet connection using a handheld device

(76) Inventor: Yen-Hung Lai, Taipei City (TW)

Correspondence Address: LADAS & PARRY LLP, 224 SOUTH MICHIGAN AVENUE, SUITE 1600, CHICAGO, IL, 60604, US

(21) Appl. No.: 11/184,415

(22) Filed: Jul. 19, 2005

(30) Foreign Application Priority Data
Dec. 13, 2004 (TW) 093138557

(51) Int. Cl. H04L 12/56; H04L 12/66

(52) U.S. Cl. 370/352; 370/401

(57) ABSTRACT

A method for establishing an Internet connection using a handheld device includes the step of, in response to an incoming call made by a communications server using a dedicated calling number, enabling operation of the handheld device for breaking a call connection with the communications server and for establishing the Internet connection. The handheld device and the communications server for realizing the method are also disclosed.

### CROSS-REFERENCE TO RELATED APPLICATION

This application claims priority of Taiwanese application no. 093138557, filed on Dec. 13, 2004.

### BACKGROUND OF THE INVENTION

1. Field of the Invention

This invention relates to a method for establishing an Internet connection using a handheld device.

2. Description of the Related Art

Mobile phones for a wireless telecommunications network, such as a global system for mobile communications (GSM) network, which provides the general packet radio service (GPRS) and the wireless applications protocol (WAP) service, are known in the art.

A conventional method for establishing an Internet connection using the conventional mobile phone includes the step of enabling manual operation of the conventional phone to establish an Internet connection via the GPRS or the WAP service.

The aforementioned conventional method is disadvantageous in that establishment of the Internet connection may be initiated only by the conventional mobile phone.

### SUMMARY OF THE INVENTION

Therefore, the object of the present invention is to provide a method for establishing an Internet connection using a handheld device in a passive mariner.

Another object of the present invention is to provide a handheld device that can establish an Internet connection in a passive manner.

According to one aspect of the present invention, a method for establishing an Internet connection using a handheld device comprises the step of, in response to an incoming call made by a communications server using a dedicated calling number, enabling operation of the handheld device for breaking a call connection with the communications server and for establishing the Internet connection.

According to another aspect of the present invention, a handheld device comprises a program module adapted to receive an incoming call made by a communications server using a dedicated calling number, and to break a call connection with the communications server and to establish an Internet connection in response to the incoming call.

According to yet another aspect of the present invention, a communications server comprises a program module operable so as to make an outgoing call for an intended handheld device using a dedicated calling number. The intended handheld device is able to respond to the outgoing call received thereby by breaking a call connection with the communications server and establishing an Internet connection.

### BRIEF DESCRIPTION OF THE DRAWINGS

Other features and advantages of the present invention will become apparent in the following detailed description of the preferred embodiment with reference to the accompanying drawings, of which;

FIG. 1 is schematic view to illustrate the preferred embodiment of a handheld device and a communications server according to the present invention; and

FIG. 2 is a flowchart to illustrate the preferred embodiment of a method for establishing an Internet connection using a handheld device according to the present invention.

### DETAILED DESCRIPTION OF THE PREFERRED EMBODIMENT

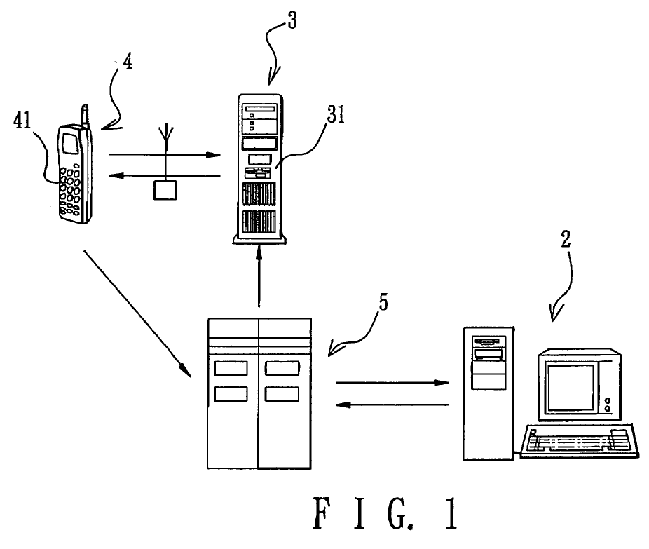

FIG. 1 illustrates the preferred embodiment of a handheld device 4 and a communications server 3 for implementing the preferred embodiment of a method for establishing an Internet connection using the handheld device 4.

In this embodiment, the handheld device 4 is a mobile phone, and includes a program module 41. In this embodiment, the program module 41 of the handheld device 4 is adapted to receive a specific call type from the communications server 3. In response to the specific call type, the program module 41 of the handheld device 4 performs the following operations: enabling user operation of the device 4 (such as by pressing anon-hook key) for acknowledging the receipt of the call; breaking a call connection with the communications server 3; and establishing an Internet connection.

It is noted that the Internet connection is established with a remote server 5 of an Internet service provider (not shown).

Once the Internet connection is established, the handheld device 4 is accessible to an external device 2 through the Internet connection. In this embodiment, the external device 2 may be a personal computer, a notebook, or a personal digital assistant (PDA).

In this embodiment, the communications server 3 is a server managed by a mobile phone service provider (not shown), and includes a program module 31. In this embodiment, the program module 31 of the communications server 3 is operable so as to make the specific call type for the handheld device 4 using a dedicated calling number. Preferably, the dedicated calling number is preset in the GSM communications protocol and is associated with the triggering of the program module 41 of the handheld device 4 for establishing the Internet connection.

It is noted that the program module 31 of the communications server 3 makes the call in response to a command issued by the external device 2, received by the remote server 5 through the Internet, and received by the program module 31 of the communications server 3 through the remote server 5.

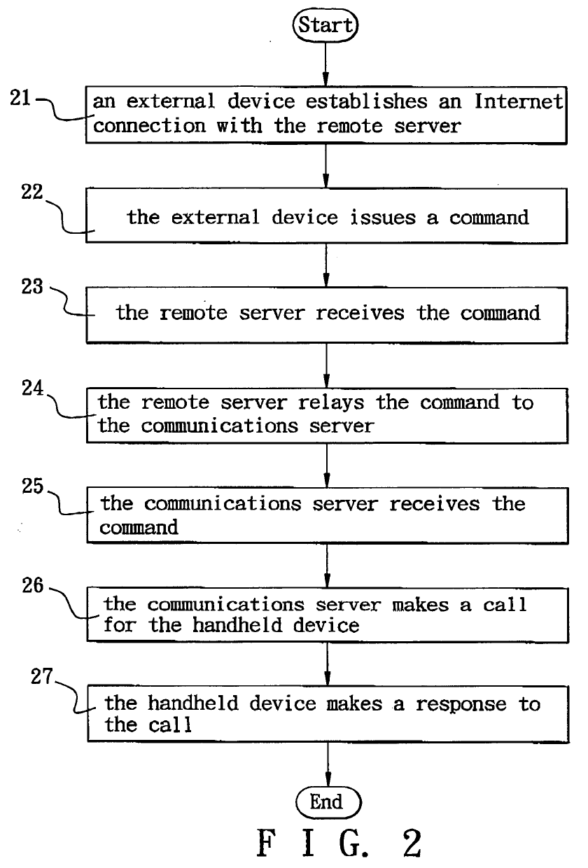

The preferred embodiment of the method for establishing the Internet connection using the handheld device 4 according to this invention will now be described with further reference to FIG. 2.

In step 21, the external device 2 establishes the Internet connection with the remote server 5 of the Internet service provider (ISP).

In step 22, the external device 2 issues the command to the remote server 5 through the Internet.

In step 23, the remote server 5 receives the command from the external device 2 through the Internet.

In step 24, the remote server 5 relays the command to the communications server 3, such as through the Internet if the ISP and the mobile phone service provider are the same.

In step 25, the program module 31 of the communications server 3 receives the command from the remote server 5.

In step 26, in response to the command, the program module 31 of the communications server 3 makes the call for the handheld device 4 using the dedicated calling number.

In step 27, in response to the specific call type made by the program module 31 of the communications server 3, the program module 41 of the handheld device 4 performs the following operations: enabling user operation of the device 4 for acknowledging the receipt of the call; breaking a call connection with the communications server 3; and establishing the Internet connection.

At this time, the handheld device 4 is accessible to the external device 2 through the Internet connection. The external device 2 is able to access the handheld device 4 through the Internet connection for performing any one of the following operations: data exchange and setting of device configurations.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for establishing an Internet connection using a handheld device, said method comprising the step of:
(A) in response to an incoming call made by a communications server using a dedicated calling number, enabling operation of the handheld device for breaking a call connection with the communications server and for establishing the Internet connection.

2. The method of claim 1, wherein the communications server is a server managed by a mobile phone service provider, and the Internet connection is established with a remote server of an Internet service provider.

3. The method of claim 1, wherein the communications server makes the incoming call in response to a command issued by an external device, received by a remote server through the Internet, and received by the communications server through the remote server.

4. The method of claim 1, wherein, in step (A), the handheld device is accessibly to an external device through the Internet connection.

5. The method of claim 4, wherein the external device is able to access the handheld device through the Internet connection for performing any one of the following operations: data exchange and setting of device configurations.

6. The method of claim 1, wherein the dedicated calling number is preset in the GSM communications protocol and is associated with triggering of the handheld device for establishing the Internet connection.

7. A handheld device comprising:
a program module adapted to receive an incoming call made by a communications server using a dedicated calling number, and to break a call connection with the communications server and to establish an Internet connection in response to the incoming call.

8. The handheld device of claim 7, wherein the communications server is a server managed by a mobile phone service provider, and the Internet connection is established with a remote server of an Internet service provider.

9. The handheld device of claim 7, wherein the program module is accessible to an external device through the Internet connection.

10. The handheld device of claim 9, wherein the external device is able to access the handheld device through the Internet connection for performing any one of the following operations: data exchange and setting of device configurations.

11. The handheld device of claim 7, wherein the dedicated calling number is preset in the GSM communications protocol and is associated with triggering of the program module for establishing the Internet connection.

12. A communications server comprising:
a program module operable so as to make an outgoing call for an intended handheld device using a dedicated calling number;
whereby, the intended handheld device is able to respond to the outgoing call received thereby by breaking a call connection with the communications server and establishing an Internet connection.

13. The communications server of claim 12, which is a server managed by a mobile phone service provider.

14. The communications server of claim 12, wherein the program module makes the outgoing call in response to a command issued by an external device, received by a remote server through the Internet, and received by the program module through the remote server.

15. The communications server of claim 12, wherein the dedicated calling number is preset in the GSM communications protocol and is associated with triggering of the handheld device for establishing the Internet connection.
